(19) United States
(12) Patent Application Publication
(10) Pub. No.: US 2020/0387765 A1
(43) Pub. Date: Dec. 10, 2020

(54) Security Measures in Relation to Data Tags and Contactless Cards

(71) Applicant: Equinox Card Ltd., London, Greater London (GB)

(72) Inventor: Jason Meers, London (GB)

(73) Assignee: Equinox Card Ltd., London, Greater London (GB)

(21) Appl. No.: 16/971,588

(22) PCT Filed: Feb. 21, 2019
(86) PCT No.: PCT/GB2019/050476

§ 371 Date: Aug. 20, 2020

(30) Foreign Application Priority Data
Feb. 23, 2018 (GB) 1802929.8
Feb. 23, 2018 (GB) 1802941.3
Feb. 23, 2018 (GB) 1802945.4
Feb. 23, 2018 (GB) 1802951.2
Feb. 23, 2018 (GB) 1802957.9

(51) Int. Cl. G06K 19/07; G06Q 20/34

(52) U.S. Cl. CPC G06K 19/0716; G06Q 20/352

(57) ABSTRACT

The invention relates to a data tag having a memory (32) for storing a data set and a contactless interface (26, 28) for supplying data from the memory to a remote reader (20). The contactless interface is configured to be interrogated through an electromagnetic field (22) from the reader. The data tag further comprises a plurality of sensors (50) which are spatially separated and which are configured to sense the interrogating electromagnetic field, and a processing device (54) configured to receive outputs from the sensors representative of the interrogating field and to: enable supply of data from the data set through the contactless interface if variability of the sensed outputs is sufficient to indicate that the reader and the data tag are in close proximity; and to disable supply of data from the data set through the contactless interface if variability of the sensed outputs is not sufficient to indicate that the reader and the data tag are in close proximity.

The present invention is concerned with data tags, which may take the form of contactless cards or RFID tags. In particular the invention is concerned with data security measures to be implemented in such devices, and with measures to ensure security of transactions made by use of them.

The term “contactless” as used herein in relation to a card or other form of electronic tag implies that data carried by the card is able to be read through a wireless interface. Known contactless cards may be interrogated through close proximity inductive coupling and/or through propagating electromagnetic waves, and the term “contactless card” must be understood to encompass, without limitation, both or either of these possibilities. Protocols used for transmission of data in this context at the time of writing include the near-field communication (NFC) protocol and other protocols applied in relation to radio-frequency identification (RFID) but the term “contactless” does not—as used herein—refer to any specific communications protocol. Some “contactless” cards do have electrical contacts which provide an alternative means of reading data from the card. At the time of writing contactless payment cards commonly have two interfaces - a contactless interface and a set of contacts for making a direct electrical connection to a reader. These are nonetheless “contactless” in the relevant sense that data carried by the card is able to be read through a wireless interface.

Contactless cards are widely used for a variety of purposes. Importantly, many payment cards issued by banks, credit card companies and other financial institutions have a contactless interface for use at a point of sale, for purposes including authorization of the transfer of funds. This is highly convenient for the purchaser, who can effect payment merely by presenting a card to a reader at the point of sale. Other applications of contactless cards include:
access management, where access barriers such as turnstiles or doors have a reader and a user is required to present a suitable card to obtain access. Hotel room keys provide one example;
verification of identity, where a bearer of a contactless card is taken to be the person identified by data on the card;
verification of attendance—some institutions of learning, for example, use contactless cards to verify students' attendance at lessons, seminars etc.;
access to resources, such as public transport, bike rentals etc.

This is far from being an exhaustive list.

It will be apparent that if a malfeasor is able to obtain unauthorized access to data from a contactless card, that data may be put to a variety of illegitimate uses. In the case of payment cards, this misappropriated data may be used to steal money from a financial account. A cloned hotel key card bearing the misappropriated data may be used for a burglary. The malfeasor may use such data to access confidential data intended for the bearer of the card, and so on.

Whereas contact-based interfaces can be interrogated only if access is available to the card itself, contactless cards suffer from the fundamental vulnerability that they can be interrogated remotely. Hence subject to whatever security precautions are taken, there is the possibility of a malfeasor reading the card without having direct physical access to it. An individual with a suitable reader may for example collect card data in a public place from passers-by.

Barring the use of suitable security measures, the technical and practical barriers to this type of abuse are not large. Cards' wireless interfaces typically conform to publicly available standards. The ISO/IEC 7816 standard which is widely adopted in relation to payment cards at the time of writing is also implemented for example in door-entry systems, car park barriers, hotel room locks, gymnasia, electricity and gas meters. The know-how required to interrogate cards using these standards is widely available, as is the hardware. One existing range of card chips and readers is sold at the time of writing under the trade mark MIFARE, owned by NXP Semiconductors, who state that 150 million readers have been sold. The contactless cards issued by financial institutions to make transactions do have a slightly different level of security from the cards used in hotels and transport networks, requiring additional vendor specific steps to translate received data into human readable form, but the additional security provided thereby is minimal. The information needed to extract customer and account information from a contactless payment card can be found in the public EMV standard which was originally developed by Mastercard® and Visa® in the early nineties.

Devices exist within the criminal fraternity that can harvest data from contactless payment cards at a rate of approximately 15 cards per second, and that remain undetectable by the typical card holder. But specialist equipment is not required. Many modern smartphones and tablets contain RFID/NFC readers, so that a standard device with a suitable application can be used to collect data from contactless cards. Applications can even be downloaded from mainstream “app stores” that are capable of reading data from contactless cards.

A particular risk arises during delivery of a contactless card to its end user. Where a contactless card is delivered by a postal service or delivery agent, there is the risk that the card may be read—even without the package in which it is contained being opened—during the delivery process, giving a malfeasor access to data from the card. There is also the risk that data may be harvested from the card for illegitimate purposes at some point in its manufacture. Interception of data on a large scale is possible by siting a reader at a suitable point in the manufacturing line, or at any suitable point in the route for packing, despatch, sorting and delivery of the cards.

As to the range over which information can be misappropriated, a typical payment card operating in the 13.56 MHz range needs to be placed within a few centimetres of a “legitimate” reader for data to be exchanged. But it is also possible to read these cards from over a metre away with the correct equipment, and from a much larger distance using a specialized antenna and related circuitry. Other frequencies can be used. For instance some standards use 125 KHz.

So for example where contactless cards are carried in public by users in coat pockets, trouser pockets or non-shielded wallets and purses there is a risk that data from the cards may be misappropriated. Fraudsters may use handheld readers for the purpose in crowded areas such as lifts (elevators), escalators, turnstiles, public transport and so on.

Data misappropriated from contactless cards can be used to make clone cards, and so for example to make fraudulent transactions. Another risk associated with contactless payment cards is that the card itself may simply be stolen and used to authorize transactions or other activities by a person other than its legitimate holder.

Both of these risks are accentuated because typical contactless transactions do not require input of any password or identity number to the point of sale reader used to make the transaction. Whereas a typical “Chip and Pin” process at a point of sale device involves reading the card and input of a personal identity number (“PIN”) through a keyboard of the point of sale device, contactless cards are accepted without any PIN input.

Another potential danger is that malware running on a user's own smartphone or tablet may be used to read that user's card and transmit its data to a malfeasor. A user's card and their mobile device may often be juxtaposed, e.g. because the user puts both in a pocket or handbag. The malware is thus able to use the mobile device's NFC/RFID interface to read the card, and its mobile (cellular) or WiFi data transmission capability to transmit the data to a malfeasor. Malware which propagates widely can in this way be used to obtain large volumes of card data without those responsible being in geographical proximity to the victims.

Fraud in relation to contactless cards is a real and current source of concern to consumers and to institutions using the technology.

Various security measures are available in this context.

One precaution that the user can take is to provide the card with a shield which blocks the signals used to exchange data. The card is placed in the shield when not in use and is intended to be removed from it only for use, e.g. at a point of sale. The shield may take the form of a sleeve to receive and surround the card. An electrically conductive layer can provide shielding, functioning in the manner of a Faraday cage. Wallets and purses claimed to screen radio frequency transmissions are commercially available. Shields provide an incomplete solution however. From the point of view of the institution issuing the card, the fact that not all users have adopted use of shields leaves them at risk. From the point of view of the end user, to be effective, a shield relies on that user manually taking the card out of the shield for use, and then returning it to the shield after use. This is potentially inconvenient for the user and there is the possibility that the card will not be returned to the shield after use, leaving it vulnerable.

US2013015955A (Verizon Patent and Licensing Inc. et al) discloses an RFID tag which may take the form of a credit card and which has a switch which is actuable by a user to change the tag from a first state in which it is not able to be activated by a carrier signal and a second state in which it is able to be activated by the carrier signal. In this way the card is disabled unless the user activates it by means of the switch. Other patent cases disclosing tags or cards whose interface is able to be activated using a switch are WO11067428A1 (Servicios Para Medios De Pago et al), US2003132301A (Massachusetts Institute of Technology), US2008011859A (Simon Phillips), US2006266831 (Douglas Kozlay), U.S. Pat. No. 8,052,052B (Intuit Inc.) and U.S. Pat. No. 7,994,920B (International Business Machines). In all these examples the card is reversibly activated/deactivated by some transient user input such as the application/withdrawal of a fingertip. Such devices add considerably to the complexity and cost of the card.

According to a first aspect of the present invention there is a data tag comprising:
a memory for storing a data set,
a contactless interface for supplying data from the memory to a remote reader, the contactless interface being configured to be interrogated through an electromagnetic field from the reader,
a plurality of sensors which are spatially separated and which are configured to sense the interrogating electromagnetic field, and
a processing device configured to receive outputs from the sensors representative of the interrogating field and to enable supply of data from the data set through the contactless interface if variability of the sensed outputs is sufficient to indicate that the reader and the data tag are in close proximity, and to disable supply of data from the data set through the contactless interface if variability of the sensed outputs is not sufficient to indicate that the reader and the data tag are in close proximity.

The data tag may be a contactless card. The data tag may be a payment card. The sensors may be spaced across a two-dimensional area of the card. The sensors may be arranged in a grid pattern. The sensors may be directional. The sensors may be sensitive to the magnetic field component of the interrogating electromagnetic field. The sensors may be Hall-effect sensors. The processing device may be configured to compare outputs from the plurality of sensors and to establish variability between the sensors as a basis for determination of proximity of the data tag to the reader. The processing device may be configured to monitor variation of sensor outputs over time as a basis for determination of proximity of the data tag to the reader. The processing device may be configured to enable supply of data if distance from the data tag to the reader is determined to be 10 cm or less. The processing device may be configured to enable supply of data if distance from the data tag to the reader is determined to be 1 cm or less. The processing device may be configured to enable supply of data if distance from the data tag to the reader is determined to be 2 mm or less. The invention also provides a portable device of the aforementioned type which is configured to be driven by power harvested from the electromagnetic field to interrogate the device. In such a portable device, the processing device may be configured to enable supply of data from the data set through the contactless interface for a predetermined period only following a determination that the reader and the data tag are in close proximity. In such a portable device the processing device may be configured to disable supply of data from the data set after the said data has been read.

According to a second aspect of the present invention there is a portable device in the form of a contactless card or a data tag, the portable device comprising a memory for storing a data set, a contactless interface for supplying data from the memory to a remote reader, and an electrically conductive connection which is disposed on a surface of the portable device and which is severable by a user, the device having two modes of operation:

a first mode in which supply of data from the data set through the contactless interface is enabled; and

a second mode in which supply of data from the data set through the contactless interface is disabled,

and being configured to operate in one of the two modes of operation when the conductive connection is unsevered, and to operate in the other of the two modes of operation when the conductive connection is severed.

The portable device may be a payment card. The conductive connection may be removable from the card to sever the connection. Severing the conductive connection may be irreversible. The electrically conductive connection may comprise a conductive layer able to be scratched away by a user to sever the connection. The conductive layer may comprise a metal film. The portable device may be configured to operate in the second mode when the conductive connection in unsevered so that supply of the data set through the contactless interface is disabled until the conductive connection has been severed. The portable device may be configured to operate in the second mode when the conductive connection is severed so that by severing the conductive connection a user is able to inhibit supply of the data set through the contactless interface. The conductive connection may be configured to control supply of electrical power to the contactless interface. The portable device may be configured to be driven by power harvested from an electromagnetic field used to interrogate the device. The conductive connection may be connected in series or in parallel with an antenna of the contactless interface. The portable device may comprise two or more conductive connections each severable by a user, and a processor configured to control supply of multiple data sets through the contactless interface in dependence on the states of the conductive connections. A payment card may comprise of two or more conductive connections each severable by a user, the card being configured to control a value limit on financial transactions in dependence on the states of the conductive connections.

According to a third aspect of the present invention there is a method of making a financial transaction at a point of sale, the method comprising:
providing a user with a data tag which is configured to be wirelessly interrogated;
providing the user with a computer application and executing the application on a computing device;
presenting the data tag to a reader at a point of sale, to request that a financial transaction be carried out;
delivering tag data read from the data tag by the reader to a first remote server;
delivering security data from the computer application to a second remote server; and
   determining whether to authorize the transaction or decline it in dependence on the security data, and, in the event that the transaction is authorized, making the transaction using the tag data.

The first and second servers may be the same server. The determination whether to authorize the transaction or decline it may be additionally based on the tag data. The method may comprise receiving through a user interface implemented on the computing device by the computer application a user instruction to inhibit authorization of transactions by use of the data tag, and inhibiting those transactions. The method may comprise subsequently receiving through the user interface implemented on the computing device by the computer application a user instruction to cease inhibiting authorization of transactions by use of the data tag, and removing the inhibition. The user input may take the form of an indication that the data tag has been lost or stolen. The method may comprise, following delivery of the tag data to the first remote server, prompting the user to provide through a user interface implemented on the computing device an input confirming that the transaction can be authorized. The transaction may not be declined unless the user input is received. The method may comprise requiring the user to carry out an authentication process in order to provide user input to the application and/or to use predetermined functions of the application. The authentication process may comprise any of entry of a password and/or number, fingerprint-based authentication, retinal scanning or imaging, voice pattern scanning or other biometric authentication processes. The security data may comprise the location of the computing device. The location of the computing device may be compared with the location of the reader in determining whether to authorize the transaction. The transaction may be declined in the event that distance from the location of the reader to the location of the computing device is above a predetermined value. The transaction may be declined in the event that distance from the location of one transaction to the location of another transaction exceeds a value which is predetermined or which is calculated according to a predetermined method. The method may comprise receiving through a user interface implemented on the computing device by the computer application a user input representing a limit on transaction value, and declining transaction which exceed that limit. The method may comprise receiving through a user interface implemented on the computing device by the computer application a user input representing a security criterion to be applied to transactions made by use of the contactless card, and implementing the security criterion. The security criterion may be a confidence level. The security criterion may be distance. The data tag may be a contactless card. The invention also provides an application for execution on a computing device to cause the computing device to implement the method, the application comprising instructions for causing the computing device to:
receive an instruction to provide the user with a prompt to provide through a user interface implemented on the computing device an input confirming that a transaction can be authorized;
provide the said prompt;
receive a user input confirming that the transaction can be authorized; and
transmit security data to a remote server confirming that the transaction can be authorized.

According to a fourth aspect of the present invention there is a contactless card comprising a memory for storing a data set, a contactless interface for supplying data from the memory to a remote reader, and a user operable switch, the device having two modes of operation:

a first mode in which supply of data from the data set through the contactless interface is disabled; and

a second mode in which supply of data from the data set through the contactless interface is enabled,

and being configured to default to the second mode and to be placed in the second mode by user actuation of the switch, the card being configured, following placement in the second mode, return to the first mode after expiry of a predetermined period.

The contactless card may be configured to return to the first mode after supplying the card data. The contactless card may return to the first mode immediately after supply of the card data. The contactless card may be a payment card. The contactless card may be configured to be driven by power harvested from an electromagnetic field used to interrogate the device. The card data may comprise an instruction to raise a value limit on a financial transaction. A payment system may comprise the contactless card and a transaction processing system which receives data from the contactless car and which authorizes or declines a transaction in dependence upon it, wherein the transaction processing system may be configured to decline transactions whose financial value is above a default limit if it does not receive the instructions to raise the value limit, and to authorize the transaction if it does not receive the instruction to raise the value limit.

According to a fifth aspect of the present invention there is a method of authorizing an action, the method comprising:
providing a user with a contactless card having a plurality of user-actuable switches;
providing a reader for contactlessly reading the card, the reader having a user interface;
presenting the card to the reader to establish data exchange between them;
providing a prompt through the user interface for the user to provide a response using the card's user-actuable switches;
receiving the user's response, which is made using the card's user-actuable switches; and
authorizing or not authorizing the action based on the user's response.

The action may be a financial transaction. The action may be a purchase at a point of sale. The contactless card may have from two to ten user-actuable switches. The card may have from three to six user-actuable switches. The prompt provided through the user interface may contain information representing the response to be made by the user to enable the action to be authorized. The prompt provided through the user interface may include a letter, number or other symbol or character, or an audible or tactile stimulus, representing at least one switch to be actuated by the user to enable the action to be authorized. The user interface may comprise a set of selectively illuminable LEDs on a point of sale device. The LEDs may be used to provide a prompt representing the response required from the user to authorize the action. The user interface may comprise a display screen. The user may be required to provide two or more temporally separated responses to authorize the action. The method after providing the prompt and receiving the user response, providing another prompt and receiving another user response, before the action is authorized. The authorization of the action may be time limited. The action being authorized may be a time limited increase in the value of a transaction to be made using the contactless card. The contactless card may comprise a plurality of user-actuable switches. A point of sale device may be configured to provide the prompt to a user and to receive the user response. The data carried by the card may be able to be read only following a successful challenge and response. The received data may comprise data derived from the user's response through a hashing function or another conversion process. Data supplied by the card may be encrypted. The prompt may represent an encryption key, the user's response may serve to input the encryption key to the card, the data transmitted by the card may be encrypted using the encryption key obtained at the card the user's response and the data may be encrypted following receipt by the reader using the encryption key.

Specific embodiments of the present invention will now be described, by way of example only, with reference to the accompanying drawings, in which:

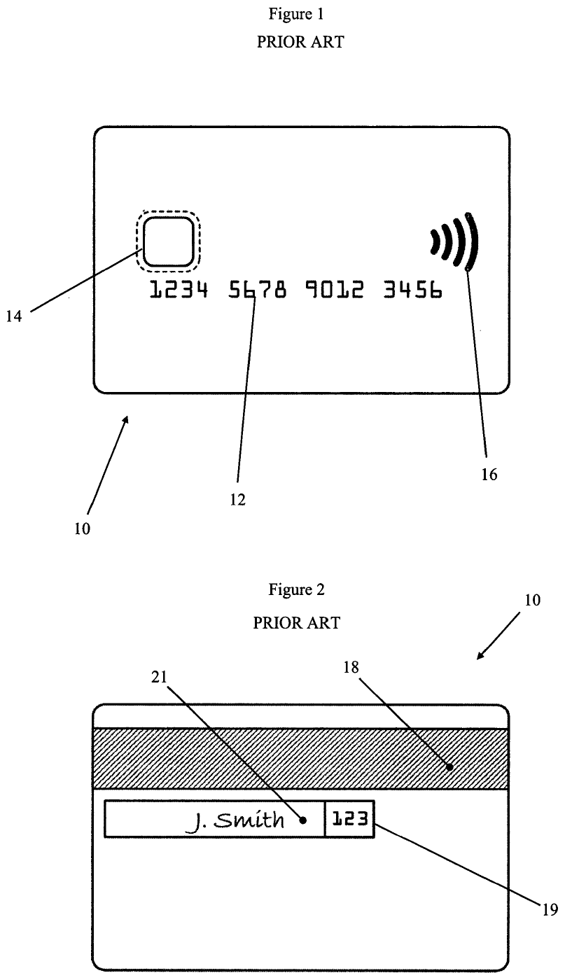

FIG. 1 depicts the exterior of a typical contactless payment card, viewed from the front;

FIG. 2 depicts the exterior of the same card, viewed from the rear;

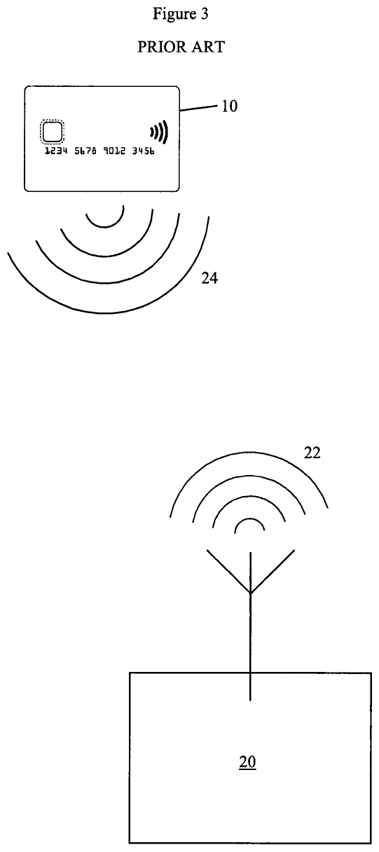

FIG. 3 is a simplified depiction of an interaction between a contactless payment card and a reader used to interrogate the card;

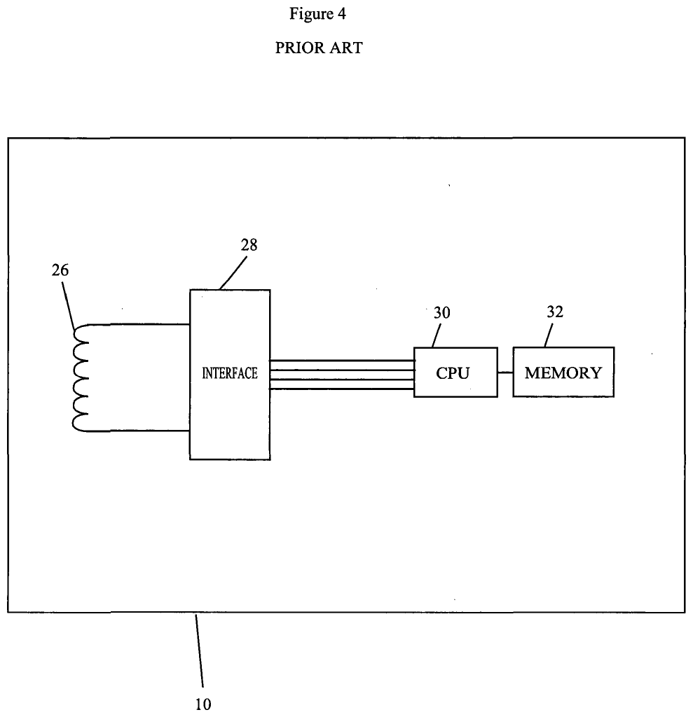

FIG. 4 is a highly schematic representation of functional components of the circuitry of a contactless card;

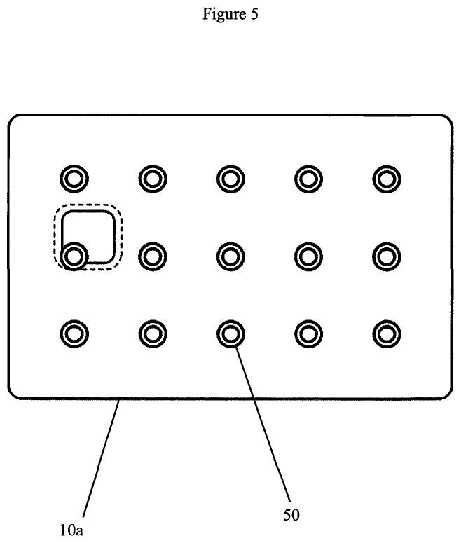

FIG. 5 is a highly schematic representation of a sensor array in a contactless card embodying the present invention;

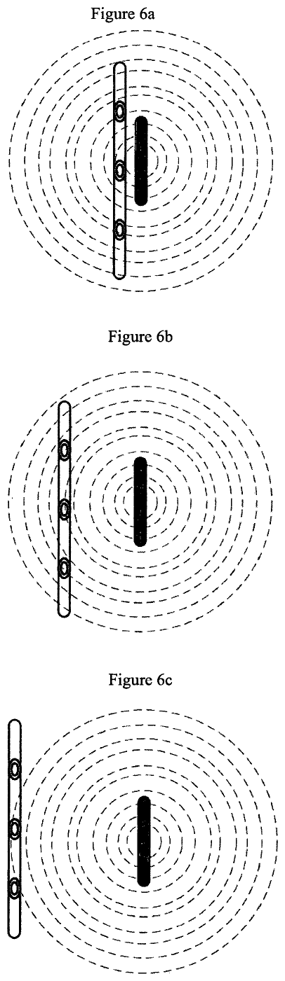

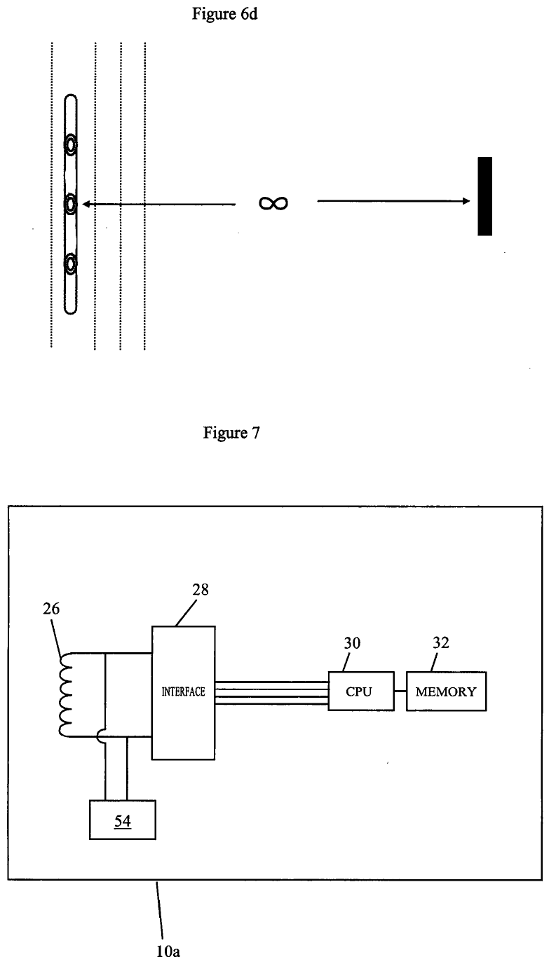

FIGS. 6a-6d represent an interaction between a card reader and a card embodying the present invention, showing magnetic field lines of an interrogating field;

FIG. 7 is a highly schematic representation of functional components of the circuitry of a contactless card embodying the present invention;

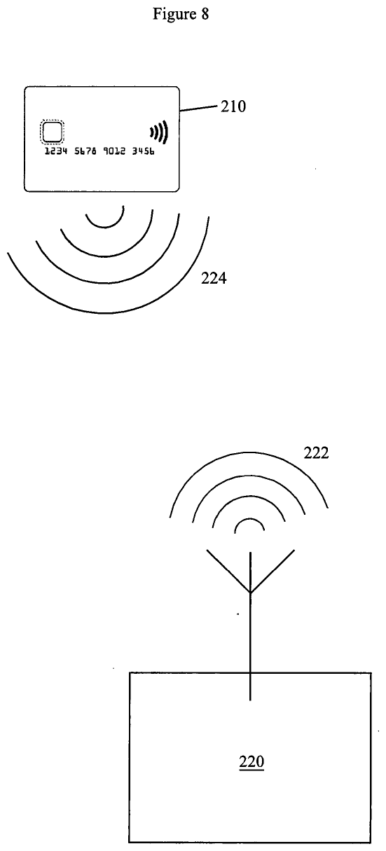

FIG. 8 is a simplified depiction of an interaction between a contactless payment card and a reader used to interrogate the card;

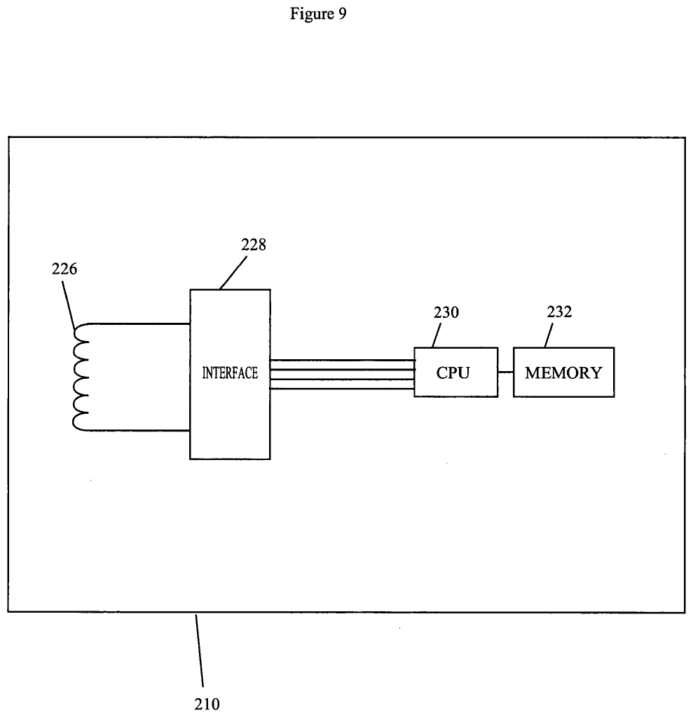

FIG. 9 is a highly schematic representation of an electronic circuit implemented on the card;

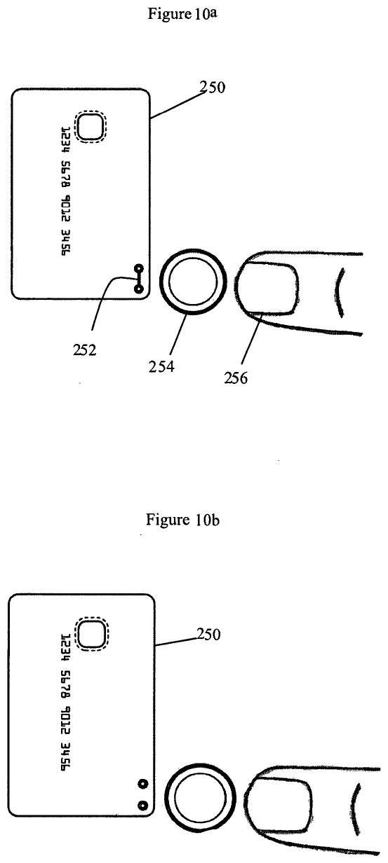

FIGS. 10a and 10b each depict an electronic payment card embodying the present invention, viewed from the front, along with a user's fingertip;

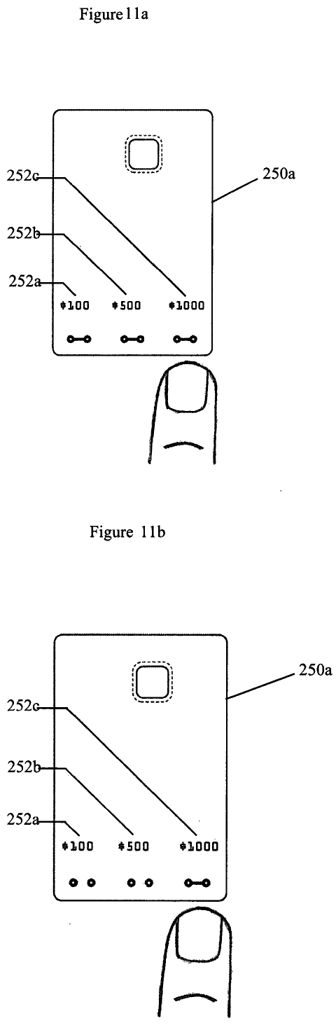

FIGS. 11a and 11b each depict a further electronic payment card embodying the present invention, viewed from the front, along with a user's fingertip;

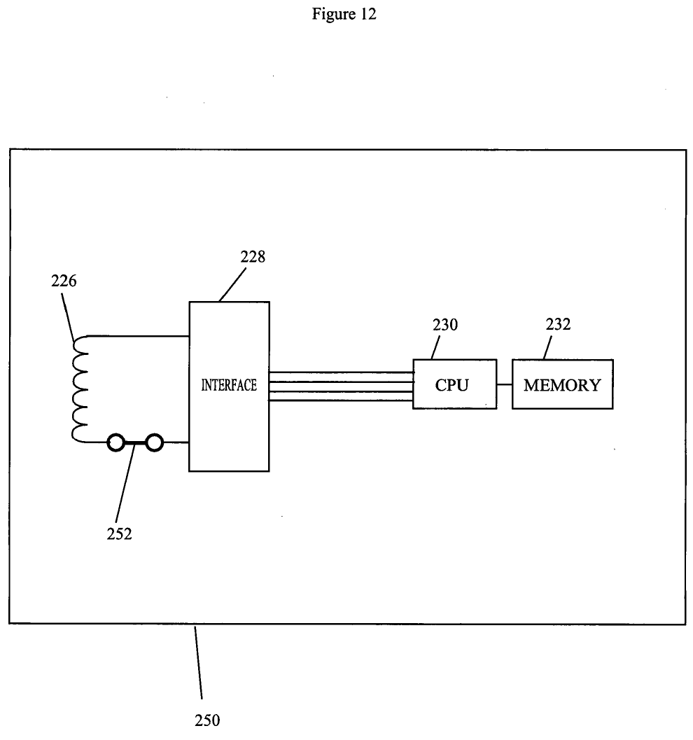

FIG. 12 is a highly schematic representation of an electronic circuit implemented on a contactless payment card embodying the present invention;

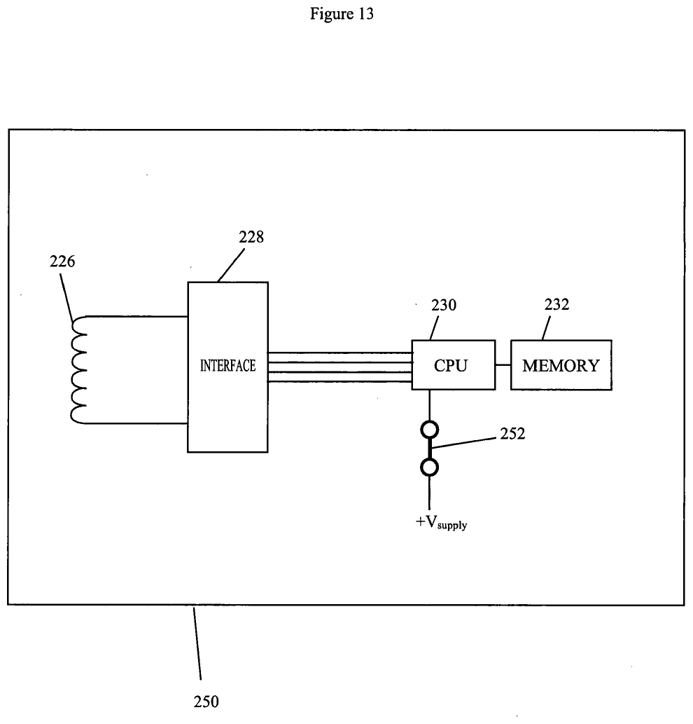

FIG. 13 is a highly schematic representation of an electronic circuit implemented on a further contactless payment card embodying the present invention;

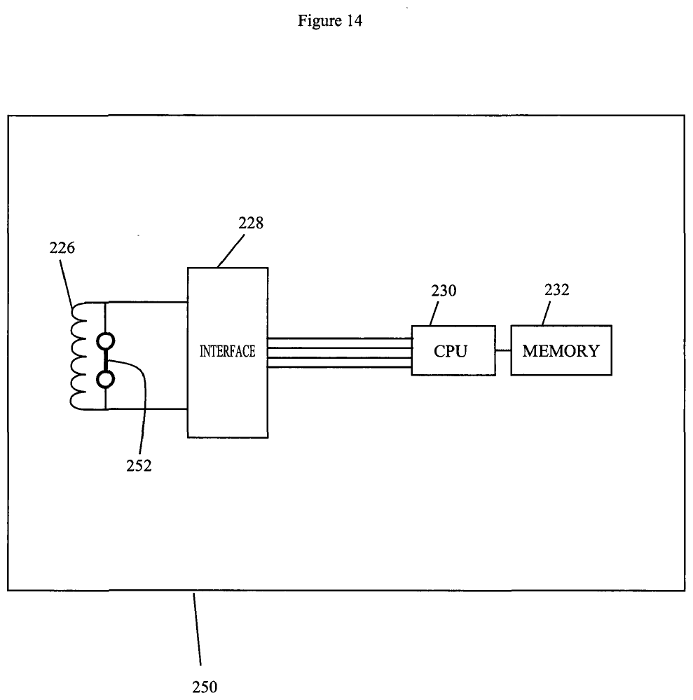

FIG. 14 is a highly schematic representation of an electronic circuit implemented on yet a further contactless payment card embodying the present invention;

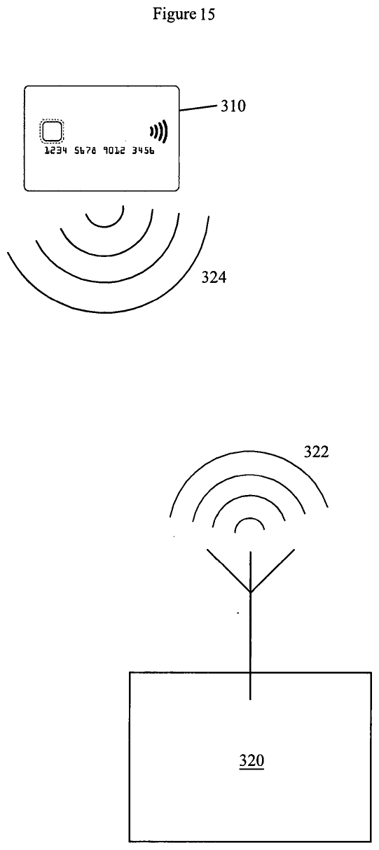

FIG. 15 is a simplified depiction of an interaction between a contactless payment card and a reader used to interrogate the card;

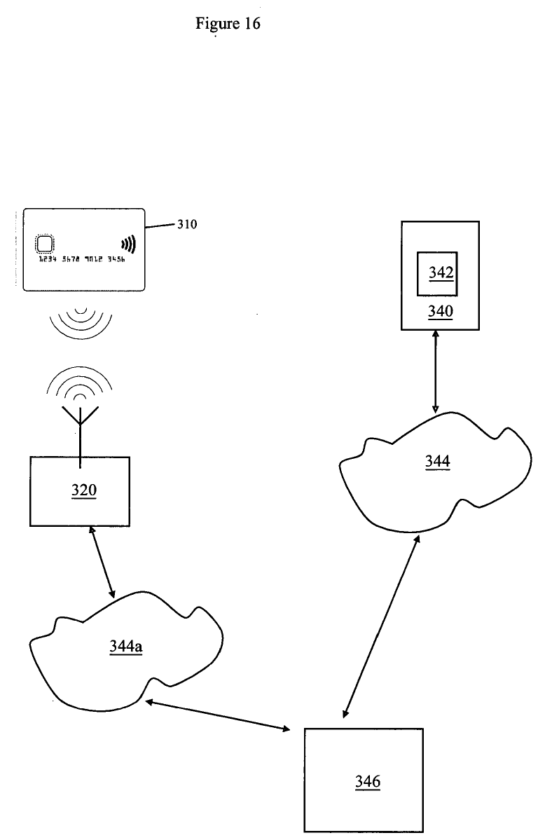

FIG. 16 is a highly simplified representation of a network architecture in which the present invention can be implemented;

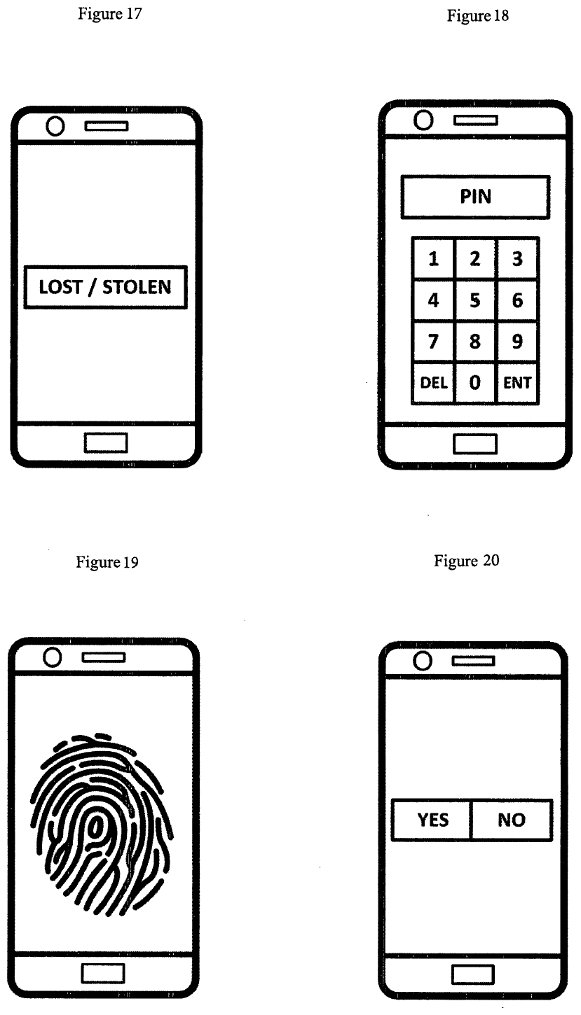

FIG. 17 shows a graphical user interface for provision of a lost or stolen notification;

FIG. 18 shows a graphical user interface for inputting a PIN;

FIG. 19 shows a graphical user interface for fingerprint authentication;

FIG. 20 shows a graphical user interface for confirming a transaction;

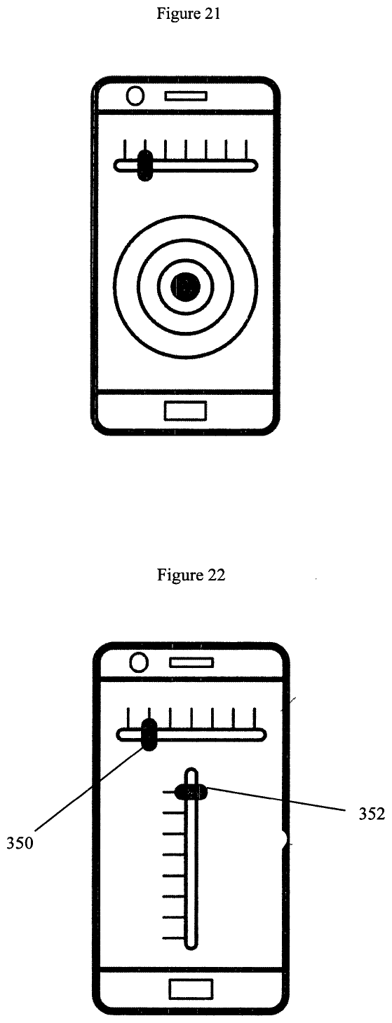

FIG. 21 shows a graphical user interface for use in representing distances;

FIG. 22 shows a graphical user interface for adjusting security parameters;

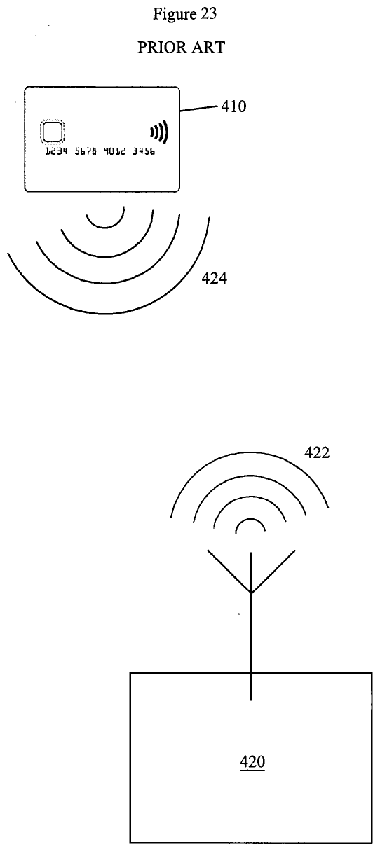

FIG. 23 is a simplified depiction of an interaction between a contactless payment card and a reader used to interrogate the card;

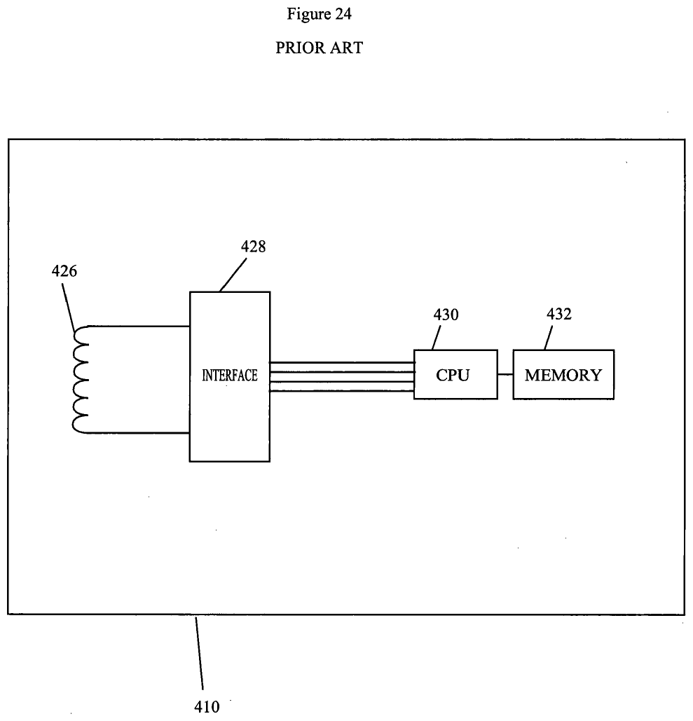

FIG. 24 is a highly schematic representation of an electronic circuit implemented on the card;

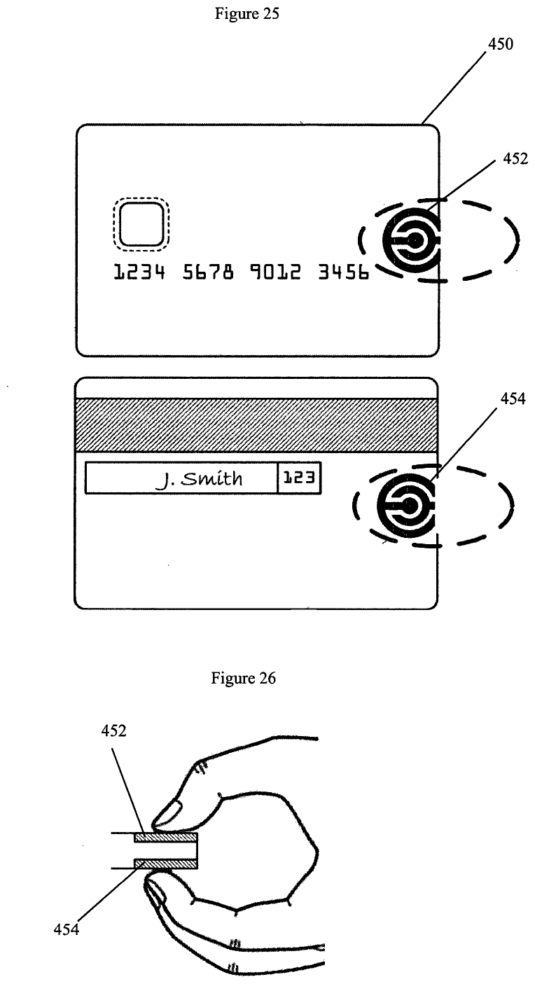

FIG. 25 shows front and rear views of a contactless payment card embodying the present invention;

FIG. 26 is a partially sectional view of the FIG. 25 card, being gripped by a user;

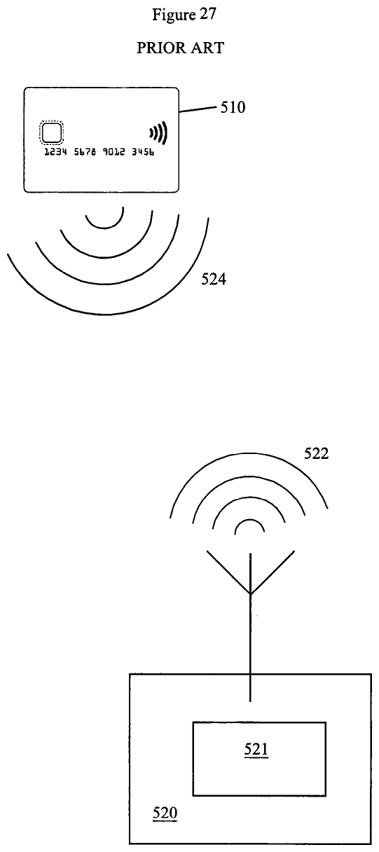

FIG. 27 is a simplified depiction of an interaction between a contactless payment card and a reader used to interrogate the card;

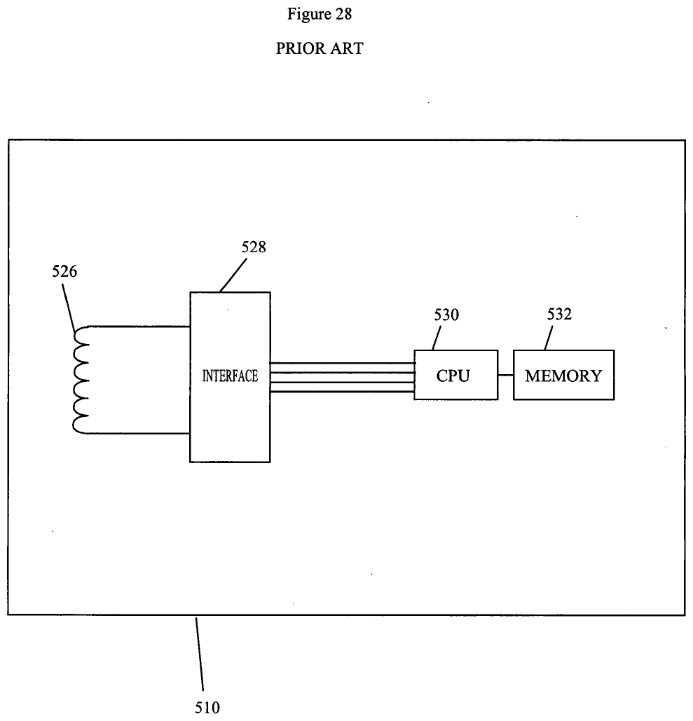

FIG. 28 is a highly schematic representation of functional components of the circuitry of a contactless card;

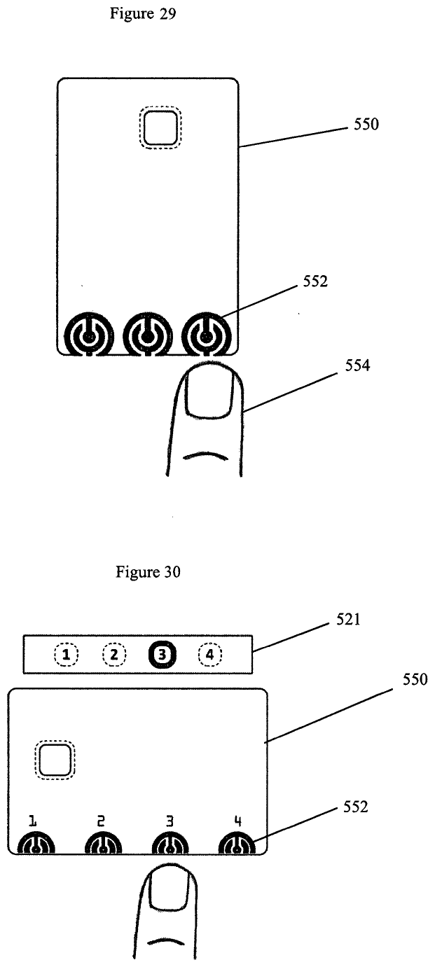

FIG. 29 shows a front view of a contactless card embodying the present invention;

FIG. 30 shows a front view of a further contactless card embodying the present invention, along with a user interface of a card reader;

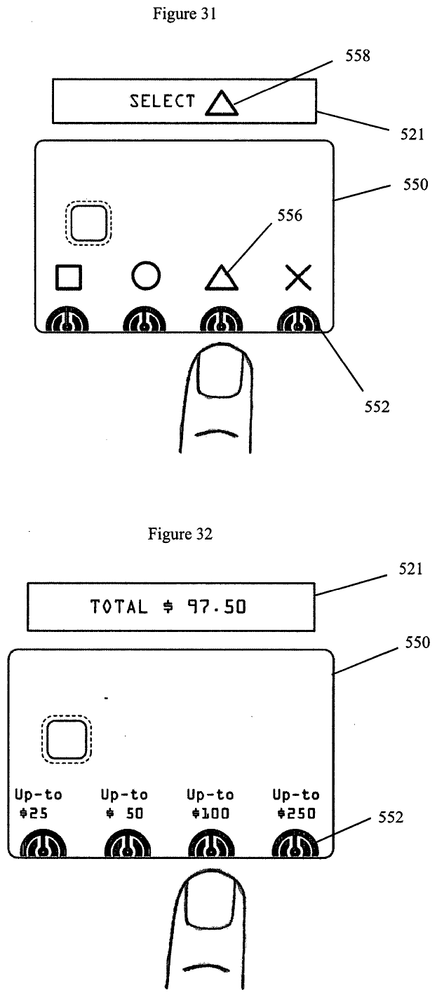

FIG. 31 shows a front view of a still a further contactless card embodying the present invention, along with the user interface of the card reader;

FIG. 32 shows a front view of yet a further contactless card embodying the present invention, along with a user interface of a card reader; and

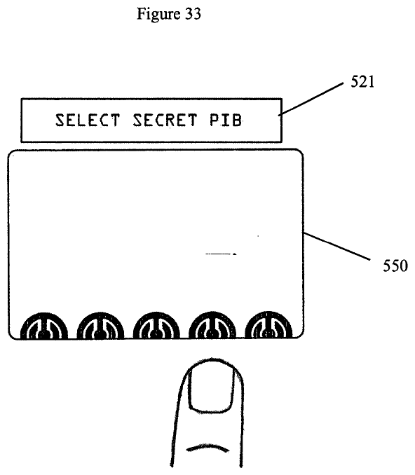

FIG. 33 shows a front view of yet a further contactless card embodying the present invention, along with a user interface of a card reader.

FIGS. 1 and 2 depict a conventional contactless payment card 10 conforming to industry standards ISO/IEC 7816 and ISO/IEC 14443. The card carries visual data including an embossed 16 digit card number 12. Other human-readable visual data printed on a typical card is omitted for the sake of simplicity. This example card 10 is able to be electronically interrogated through any of three different devices:
a contact chip 14 having multiple exposed electrical contacts conforming to the EMV standard, often referred to by the names “Chip and Pin” or “Chip and Signature”, according to the method of authentication employed by the card issuer. To use this interface the card is normally inserted into a reader which makes physical connections to the contacts to interrogate the contact chip;
a contactless interface housed within the card, whose components are formed by an inner layer of the card not visible from its exterior and whose presence is indicated by a logo 16 on the card; and
a magnetic strip 18 on the rear of the card, which is provided for the sake of backwards compatibility, being used in older point of sale devices.

The rear of the card also carries visible alphanumeric characters 19 representing a CVV or CVV2 code, which is used in some online and telephone transactions, and a signature strip 21.

Invention 1

In a contactless interaction the card 10 is read by a remote reader 20 (FIG. 3) which may for example be a point of sale device used to authorize a financial transaction. The reader need not be in physical contact with the card 10. The reader 20 interrogates the card through an interrogating electromagnetic field 22. In response the card 10 transmits data to the reader 20 through a suitably modulated data transmission electromagnetic field 24.

FIG. 4 is a highly simplified representation of the architecture of the electronics of the card 10 as they pertain to exchange of data through the contactless interface. This is presented by way of example and not limitation. Other architectures may be adopted in embodiments of the present invention. The card 10 has a contactless interface comprising an antenna 26, which is depicted in this example as an inductive element, and associated interface electronics 28. The card 10 is in this example of the “passive” type which runs on power harvested through the antenna 26 from the interrogating electromagnetic field 22 generated by the reader 20. The invention may however be implemented in “active” cards having an on-board power supply. The interface electronics 28 comprise a voltage regulator through which power received from the interrogating electromagnetic field 22 is supplied to the card's other circuitry, and an RF modulator/demodulator function. The technical implementation of these functions is known in the art and familiar to the skilled person.

FIG. 4 is wholly schematic and does not purport to represent the physical layout of the relevant components. In a practical implementation the antenna 26 is typically formed as a conductive loop extending repeatedly around the card close to its perimeter.

In the present example the card 10 further comprises a processing unit 30 and associated memory 32, which may, without limitation, comprise read only memory, non-volatile random access memory and/or EEPROM (electrically erasable programmable read only memory). The memory 32 stores, among other items, a data set which the card 10 is able to transmit to the reader 20 through the contactless interface 26, 28. In the case of a payment card, this data set includes in particular the identity and security information needed for authorization of a financial transaction. In this case its transmission to malfeasors would pose a security risk to the user. The data set typically includes data which is written to the card before its delivery to the end user.

Where a contactless card is used by its authorized bearer, the card 10 is typically presented to the reader 20 so that distance between the two is small. Existing point of sale devices of the inductive close coupled type, for example, typically require the card to be directly presented to or even touched against a reader. Unauthorized reading of the card is often carried out without the malfeasor being in physical possession of the card, and the distance between the reader 20 and the card 10 is therefore typically larger. By distinguishing these two situations it is possible, in accordance with the present invention, to distinguish between authorized and unauthorized attempts to access the card's data, and to control supply of that data accordingly.

The present embodiment uses a plurality of sensors which are spatially separated from another and which sense the interrogating electromagnetic field. In this way the degree of local inhomogeneity of the field is assessed on the basis of the sensor outputs, as an indicator of distance between the reader 20 and the card. A high degree of local inhomogeneity is expected where the distance is small. A lower degree of local inhomogeneity is expected where the distance is larger.

FIG. 5 represents a contactless card 10a embodying the present invention, which has a set of field sensors 50 each configured to respond to the local electromagnetic interrogating field 22. The sensors 50 are spaced across a two-dimensional area of the card. They are in the present embodiment arranged in a grid, although other sensor arrangements may be adopted in other embodiments of the invention.

FIG. 6 illustrates how local inhomogeneity of the interrogating field arises. The reader, which is the source of the interrogating field, is once more designated 20. Dotted lines 52 around it are the magnetic field lines of the interrogating field. The card 10a is viewed end-on, so that upper, middle and lower sensors 50a, 50b and 50c are visible. In FIG. 6a, the card 50 is very close to the reader 20. In the region of middle sensor 50b, the lines of magnetic field run roughly parallel to the plane of the card 10a, in this example. In the regions of the upper and lower sensors 50a, 50c the magnetic field vectors are roughly perpendicular to the same plane. So variation of both (a) magnetic field strength and (b) magnetic field direction between the different sensors can be expected to be large. As the distance from the reader 20 to the card 10a increases (FIGS. 6b and 6c), the variation in field direction and strength across the sensor array decreases. If one considers the reader 20 to be at infinity (FIG. 6d) then the magnetic field lines are straight and the field is constant across the sensor array.

This provides a means of distinguishing between (a) a case where the card 10a is interrogated by a reader 20 in close proximity to it, and (b) a case where the card 10a is interrogated by a reader 20 at a greater distance. Specifically, a large variation in measured field properties across the sensor array indicates that the distance is small, and a small variation in these properties indicates that the distance is large.

The sensors 50 may take any of a variety of different forms. They may in some embodiments have an isotropic response—that is, a field of a given strength will give the same sensor output regardless of its direction. In such embodiments the degree of inhomogeneity of the field strength of the interrogating field can be monitored. But in the present embodiment the sensors 50 have a directional response. That is, they respond preferentially to fields whose field vectors lie along a specific direction (or directions). In this way the sensor array 50 is able to respond to the variation in field vector direction represented in FIG. 6.

The sensors 50 may in principle respond to the magnetic component of the interrogating field or to its electrical component, or both.

In the present embodiment, the sensors 50 are Hall-effect sensors. The operation of a Hall-effect sensor is very well known to the skilled person. Commercial Hall effect sensors are very widely available. Hence their operation will not be described in detail herein, but very briefly a Hall-effect sensor typically has a conductor supplied with an electrical current and exposed to a magnetic field. The magnetic field exerts a force on the moving charge carriers, creating a potential difference across the conductor which can be converted to the sensor's output. Hall-effect sensors are directional (anisotropic), responding preferentially to magnetic field vectors in certain directions.

Outputs from the sensors 50 are led to logic circuitry for processing. In some embodiments the same CPU 30 used to supply data through the contactless interface 26, 28 is also used to process the sensor outputs and control data supply in response to them. But the present embodiment (FIG. 7) has a second logic device 54 from the CPU 32 to process the sensor outputs. The second logic device 54 and the array of sensors 50 are both powered from the same antenna 26 used for data exchange, so that they are activated and powered by the interrogating field 22. The second logic device 54 may be a programmed microprocessor, although simpler logic devices or indeed analogue processing circuitry may instead suffice in certain embodiments. Based on the sensor signals, delivery of the aforementioned data set through the contactless interface 26, 28 is either enabled or disabled. This may for example be achieved through a digital signal sent by the logic device 54 to the CPU 30 to enable/disable data delivery, or through a switch controlling supply of power to the CPU 30 and/or interface 26, 28 which is closed to enable data delivery.

The processing of the signals from the sensors 50 may include determination of signal variation as an indication of proximity of the card 10a to the reader 20. It may include determination of the degree of inhomogeneity of the field across the array of sensors 50.

The signal processing may also include determination of dynamic aspects of the sensor outputs as an indicator of proximity of the card to the reader. Moving the card 10a into a position close to the reader 20 is expected to produce dynamic variations in the field strengths experienced by the sensors 50. Hence variation of sensor outputs with time is large during such movement used in a legitimate transaction to position the card 10a on or adjacent the reader 20. These time variations in the sensor outputs can be detected to provide a further indication that the card is being read from a proximally situated reader.

Based on the outputs of the sensors 50, the second logic device 54 is configured to make a determination of whether supply of data from the data set should be enabled or disabled. In the case of a contactless payment card, enablement of data supply makes possible transfer of the card data needed to make a payment. Disablement of data supply prevents a transaction being made, and also of course serves to protect the card from being remotely read by a malfeasor. Typically the supply of data will be disabled by default, and enabled only in response to a suitable determination by the second logic device 54. Hence the card 10a is at most times (and save when being legitimately interrogated) prevented from supplying sensitive data through the contactless interface 26, 28.

In the present embodiment, following a determination that data supply is to be enabled, this enablement takes place for no more than a predetermined period. For example, a ten second window may be provided following enablement within which data supply is able to take place. After that period, the card returns to a state in which data supply is disabled. Since enablement takes place when the card has already received the interrogating signal, this limited window provides time for the required data supply to the reader 20. But it limits any opportunity for a fraudulent reading of the card data to take place during or immediately after a legitimate transaction.

Also according to the present embodiment data supply is disabled immediately after a legitimate reading of the card date has been completed, which further curtails any opportunity for fraudulent reading of the card.

The present invention is especially suitable for implementation using cards but can be applied to data tags of any kind including wearable devices or portable computing devices.

Invention 2

In a contactless interaction the card 210 is read by a remote reader 220 (FIG. 8) which may for example be a point of sale device used to authorize a financial transaction. The reader need not be in physical contact with the card 210. The reader 220 interrogates the card through an interrogating electromagnetic field 222. In response the card 210 transmits data to the reader 220 through a suitably modulated data transmission electromagnetic field 224.

FIG. 9 is a highly simplified representation of the architecture of the electronics of the card 210 as they pertain to exchange of data through the contactless interface. This is presented by way of example and not limitation. Other architectures may be adopted in embodiments of the present invention. The card 210 has a contactless interface comprising an antenna 226, which is depicted in this example as an inductive element, and associated interface electronics 228. The card 210 is in this example of the “passive” type which runs on power harvested through the antenna 226 from the interrogating electromagnetic field 222 generated by the reader 220. The invention may however be implemented in “active” cards having an on-board power supply. The interface electronics 228 comprise a voltage regulator through which power received from the interrogating electromagnetic field 222 is supplied to the card's other circuitry, and an RF modulator/demodulator function. The technical implementation of these functions is known in the art and familiar to the skilled person.

FIG. 9 is wholly schematic and does not purport to represent the physical layout of the relevant components. In a practical implementation the antenna 226 is typically formed as a conductive loop extending repeatedly around the card close to its perimeter.

In the present example the card 210 further comprises a processing unit 230 and associated memory 232, which may, without limitation, comprise read only memory, non-volatile random access memory and/or EEPROM (electrically erasable programmable read only memory). The memory 232 stores, among other items, a data set which the card 210 is able to transmit to the reader 220 through the contactless interface 226, 228. In the case of a payment card, this data set includes in particular the identity and security information needed for authorization of a financial transaction. In this case its transmission to malfeasors would pose a security risk to the user. The data set typically includes data which is written to the card before its delivery to the end user.

FIG. 10a depicts a contactless card 250 which embodies the present invention, which has in the present embodiment the features of appearance, architecture and function described above with reference to FIGS. 1 to 5, and which additionally comprises an electrically conductive connection 252 disposed on an exterior face of the card 250. The conductive connection 252 controls access to the aforementioned data set through the contactless interface.

The conductive connection 252 is formed in a manner which enables it to be severed by a user. In the present embodiment it comprises a metal layer applied to the front face of the card 250. The metal layer is able to be scratched away using for example a coin 254 or a fingernail 256. In this way a path through the conductive connection between electronic components of the card 250 is severed—see FIG. 10b, showing the state of the card after severing of the conductive connection 252.

In another possible embodiment the conductive connection 252 comprises a self-adhesive “peel-off” sticker with an electrically conductive connection which bridges contacts on the card 250 when present, so that removal of the sticker severs the electrical connection.

Severing of the conductive connection 252 in both of these examples involves its total or partial removal. In the case of a metal film, the material of the film is to be scratched away and so removed from the card 250. In the case of a sticker, the conductor forming the conductive connection 252 is removed along with the sticker.

The severing of the conductive connection 252 may be irreversible, in the sense that the physical process by which it is carried out cannot be undone. This is the case for example where the conductive connection 252 is formed by a metal film, which cannot be reconstituted once it has been scratched away.

According to whether the conductive connection 252 is severed or unsevered, the card 250 operates in one of two different modes:

a first mode in which supply of data from the data set through the contactless interface is enabled; and

a second mode in which supply of data from the data set through the contactless interface is disabled.

This makes possible a variety of different security functions.

To address the problem referred to above of data being misappropriated during delivery of the card 250, it may be initially configured in the second mode, in which the data set cannot be read through the contactless interface. In such an embodiment the conductive connection 252 is initially unsevered and the card 250 is thereby maintained in the second mode, making harvesting of data during delivery impossible. To activate the card following its delivery the end user simply severs the conductive connection 252, placing the card in the first mode and so making it ready for use. Alternatively if the user does not intend to use the contactless interface 226, 228 then he/she may choose never to sever the conductive connection 252.

When the card 250 has been packaged for delivery (e.g. in an envelope), severing the conductive connection 252 necessarily entails opening the package to gain access to the card. The tampering with the package, and the absence of the conductive connection 252, would then be apparent to the end user upon delivery.

The card 250 may alternatively be maintained in the first mode while the conductive connection 252 is unsevered, and changed to the second mode by severing of the connection. This gives the end user a means of selectively disabling the delivery of the data set through the contactless interface 226, 228. In the case of a payment card, for example, the end user may choose to sever the conductive connection 252 to deactivate the contactless function, after which the card would not be capable of use in contactless transactions. The user might then rely on the card's “Chip and Pin” interface 214 and its magnetic strip 218.

The card may have more than one severable electrically conductive connection 252. FIGS. 11a and 11b depict an example. Here, the user is able to select one of several different limits on the value of transactions that can be made using the contactless interface. The card 250a depicted in these drawings has three separate conductive connections 252a, 252b, 252c, each corresponding to a different limit on transaction value. When the card 250a is delivered to the user, all three are intact as depicted in FIG. 11a and the delivery of the data set through the contactless interface 226, 228 is disabled, making the card secure during its manufacture and delivery. The user must sever at least one of the conductive connections 252a, 252b, 252c to ready the card for use. By choosing which connection to sever, the user selects a value limit. In a simple case, severing of a given conductive connection 252a, 252b, 252c enables transactions up to a corresponding value limit. So severing first conductive connection 252a in this example enables transactions up to $100. Severing second conductive connection 252b enables transactions up to $500. Severing third conductive connection 252c enables transactions up to $1000. An alternative is that different permutations of severed and unsevered connections may represent different value limits. So for example severing two connections may enable transactions up to the sum of the values they represent. In FIG. 11b the first and second conductive connections 252a, 252b have been severed and the value limit is the sum of the values they represent—i.e. $100+$500=$600.

In order to implement the variable limit on transaction value, the card 250a stores multiple data sets, delivery of which is selectively inhibited. In the simplest case, each of these data sets encodes a specific transaction value limit.

As to the manner in which the electrically conductive connection 252 controls the delivery of the data set through the contactless interface 226, 228, there are various possibilities. The conductive connection 252 may directly control supply of power to the card's electronics, e.g. being in series connection in a line through which power is supplied to drive the card's electronics, as depicted in FIG. 12. The conductive connection 252 may instead apply a binary signal to an input of the processing unit 230, which controls output of the data set in dependence on this input—see FIG. 213.

In other embodiments the electrical connection 252 may serve to short circuit elements of the antenna 226. It may for example be connected in parallel with the antenna 226 as depicted in FIG. 214. Whilst unsevered, the electrical connection 252 thus impairs the antenna's function. In particular it may alter the resonant frequency of the antenna, making the card 250 unresponsive to the interrogating field.

The above described embodiments serve as examples only of the manner in which the present invention can be implemented. Numerous possible variants and alternatives will be apparent to the skilled reader. In particular, while the embodiments described all take the form of cards, the invention could be packaged in portable devices taking other forms including portable fobs to be carried e.g. on a lanyard.

Invention 3

In a contactless interaction the card 310 is read by a remote reader 320 (FIG. 15) which may for example be a point of sale device used to authorize a financial transaction. The reader need not be in physical contact with the card 310. The reader 320 interrogates the card through an interrogating electromagnetic field 322. In response the card 310 transmits card data to the reader 320 through a suitably modulated data transmission electromagnetic field 324.

In embodiments of the present invention, a user is provided with the facility to use an application 342 running on a computing device 340 to control functions relating to use of the contactless card 310.

The computing device 340 may be a portable device, which may without limitation take the form of a mobile phone (cellular phone), smart phone, smart watch, tablet, or laptop computer. Alternatively the computing device may be a desktop computer or other non-portable device. Preferably a portable device for use in accordance with the present invention has the facility for non-wired connectivity to a wide area network, which may without limitation be through a mobile (cellular) communications network, or through wireless connectivity to a local area network (e.g. WiFi).

One possible architecture for implementing the present invention is depicted in FIG. 16. The computing device 340 runs the application 342 and provides data through a wide area network 344, which may comprise the internet and which may additionally or alternatively comprise a mobile telephony network or local area network, to a server 346 involved in authorization of payment. The illustrated architecture is highly simplified. In practice multiple servers associated with more than one organization may be included in the architecture and involved in effecting a transaction or other relevant action. The path for communication of the computing device 340 with the server 346 may be via one or more intermediary servers/devices/networks.

The contactless payment card 310 communicates with a reader 320 which may without limitation be a point of sale device. The reader 320 in turn is in communication with the server 346 through a wide area network 344a, which may comprise the internet.

The invention makes possible a variety of advantageous functions relating to security and to authorization of actions.

The application 342 may provide the user with facilities to control authorization of transactions being made using the contactless payment card 310. These facilities may include the facility to selectively inhibit authorization of transactions.

One circumstance in which it may be necessary to inhibit making transactions by means of the contactless card 310 is where the card is lost or stolen. The application 342 provides, through its user interface, a facility for the user to report loss of the card—see FIG. 17. In response to user input indicating loss of the card, the application 342 is configured to transmit a transaction inhibit instruction to the server 346, following which the server 346 will block financial transactions using the card until the transaction inhibit instruction is countermanded. The card issuer can be automatically informed. Any form of EMV payment transactions, or other transactions, can be immediately inhibited. Where the card is inserted, following issuance of the transaction inhibit instruction in relation to it, into an ATM (automatic teller machine), the card can be retained by the machine, preventing it from being returned to what may be an unauthorized user.

The facility to inhibit authorization of actions by means of the contactless card 310 may be applicable to circumstances other than loss or theft of the card. It may be reversible by the user. That is, the card user may be given the facility to inhibit authorization of actions through the application 342, and to remove that inhibition through the application 342. This facility may be used for example if the user expects not to need or be able to use the card for a period, e.g. because of a camping, cycling or other outdoor trip taking the user away from merchants, or because the user is taking a long haul flight where pop-up notifications such as discussed below cannot be received.

The application 342 may be implement a user authentication process intended to prevent operation of the application 342 by unauthorized users. The user authentication may be carried out upon login, or prior to use of selected security sensitive functions. The user authentication method may without limitation comprise any of the following:
entry of a password;
entry of a personal identification number (see FIG. 18);
retinal scanning;
fingerprint scanning (see FIG. 19);
voice pattern sampling;
other biometric analysis;
two factor authentication (2FA);
use of the SMS messaging service, e.g. to send a code to the user which must be entered for authentication.

In this way unauthorized users are denied access to the application, or to sensitive functions it provides.

In some embodiments of the present invention, a transaction or other action requested using the contactless card 310 is required to be authorized through the application 342. Thus for example when the server 46 receives a transaction request made through the reader 320 using the contactless card 310, it does not immediately permit processing of the transaction. Instead it sends a verification request to the application 342 running on the computing device 340, which may for example be a mobile phone carried on the user's person. The mobile phone may display details of the transaction. It provides a prompt to its user to provide an input to verify the transaction, e.g. by pressing a “YES” button—see FIG. 20. In the case of a normal transaction, of course, the card bearer and the user of the computing device 340 are the same individual. That individual first presents the contactless card 310 to initiate the transaction, then provides the verification input to the computing device 340 to verify it, and the transaction proceeds. If the contactless card 310 has been stolen, its bearer will either not be in possession of the computing device 340, or will not be able to login to the application 342, and in either case will be unable to provide the verification signal. The transaction thus cannot proceed and fraudulent use of the contactless card 310 is prevented. This verification process may be applied to all transactions, or it may be selectively applied, e.g. to transactions over a certain value, or it may be applied only if other factors (including any of the other factors discussed herein) suggest a possible security concern.

In other embodiments the user is able to carry out authentication before initiating a transaction or other process.

Additional or alternative security measures may be implemented using metrics and/or telemetrics derived from the computing device 340 and/or from uses of the contactless card 310. Without limitation, these may include:
the location(s) of actions being made using the contactless card 310 (e.g. the locations of merchants at which the contactless card 310 is used);
distance from one known location to another;
transaction value; and
any limit or threshold placed on the card by the card issuer or by its authorized bearer.

So far as security measures based on a known distance are concerned, there are various possibilities.

The system may respond to distance between the location of a point of use of the contactless card 310 and the location of the computing device 340. Where for example the computing device 40 is a mobile phone, the application 342 is able to establish the phone's location. This may be done using a positioning system. At the time of writing mobile phones are typically configured to make use of the GPS (Global Positioning System), although other positioning systems, based on satellite signals or on other wireless signals, may be used. Alternatively the phone may use other positional data to establish its geographical location. Cell ID can be used for the purpose, or location-aware services including WiFi, Geographic-IP lookup, Service Provider IP lookup etc. The application 342 can thus report the geographical location of the computing device 340 to the server 346. When the contactless card 310 is read by a reader 320, the geographical location of the reader 320 can also be known, e.g. because the identity and location of the reader 320 are stored in a database, or because the reader 320 reports its own location.

A difference between the location of the computing device 340 and the location of the reader 320 can be interpreted as raising a security concern in relation to the action. This may be on the assumption that the card 310 and the computing device 340 are normally both carried by the user on his/her person. If the two are not in the same place, this is suggestive that one or other may have been lost or stolen. The transaction (or other action) may be blocked in response.

The system may additionally or alternatively take account, in assessing security of a transaction, of any of the following:

the distance of the computing device 340 from the point of use of the contactless card 310 at the current time;

the distance that the computing device 340 has been from the point of use within a period prior to the current time, for example within X km of the point of use in the last Y minutes.

The application 342 may provide an ability to check-in periodically (e.g. every X minutes). This check-in may be carried out automatically by the application 342 or may require user input to the computing device 340. The application 342 may, in a check-in, report its location. Because users often carry the relevant computing device 340 (which may be a mobile phone) on their person, the mobile device check-in functionality can be used to determine if the registered user is likely to be the person making a transaction at any point in time.

A graphical user interface for use in this context is depicted in FIG. 21.

The system may additionally or alternatively respond to some other distance, which may be distance between a point of use of the contactless card 310 and an address associated with the card, so that a transaction will be blocked or questioned if it takes place outside a certain geographical area.

The distance in question may be from one point of use of the contactless card 310 to the next. In this case allowance may be made for the time between two transactions. If a cloned card exists, so that a use of the cloned card may follow a use of the genuine card, then the distance between two uses of apparently the same card may be large. Hence a large distance between one transaction and another may be interpreted as indicative of a security problem, especially if the time between the two transactions is small.

The more transactions that occur in a given locality in a certain period, the greater can be the confidence of their legitimacy when combined with the mobile check-in location information.

The application 342 can provide its user with the facility to impose variable limits or security criteria, or a combination of both, on actions to be carried out using the contactless card 310. Typically the actions in question will be financial transactions.

The application 342 may give the user the facility to adjust a limit on transactions, which may for example be a limit on the value of a single transaction, or a limit on the cumulative value of transactions, or a limit on the cumulative value of transactions within a chosen period of time. Such adjustment may be carried out through a suitable graphical user interface, or through keyboard input.

The application 342 may, following authentication, be used by the user to obtain a single use code, e.g. in the format of a credit card number, for making a large value transaction, such as purchase of a holiday or motor car. The single use code may be used in a telephone transaction.

The application 342 may give the user the facility to adjust security criteria itself. For example, the user may decide—and input through the application 342—that any transaction over a value X which is more than Y kilometres from the user's registered address, or more than Z kilometres from the last transaction, should be challenged or blocked.

The user may adjust a security confidence level, with the precise implications of that adjustment being determined according to criteria determined by for example the payment service or card provider.

FIG. 22 shows a graphical user interface to enable the user to make the required adjustments using multiple sliders 350, 352.

Invention 4

In a contactless interaction the card 410 is read by a remote reader 420 (FIG. 23) which may for example be a point of sale device used to authorize a financial transaction. The reader need not be in physical contact with the card 410. The reader 420 interrogates the card through an interrogating electromagnetic field 422. In response the card 410 transmits data to the reader 420 through a suitably modulated data transmission electromagnetic field 24.

FIG. 24 is a highly simplified representation of the architecture of the electronics of the card 410 as they pertain to exchange of data through the contactless interface. This is presented by way of example and not limitation. Other architectures may be adopted in embodiments of the present invention. The card 410 has a contactless interface comprising an antenna 426, which is depicted in this example as an inductive element, and associated interface electronics 428. The card 410 is in this example of the “passive” type which runs on power harvested through the antenna 426 from the interrogating electromagnetic field 422 generated by the reader 420. The invention may however be implemented in “active” cards having an on-board power supply. The interface electronics 428 comprise a voltage regulator through which power received from the interrogating electromagnetic field 422 is supplied to the card's other circuitry, and an RF modulator/demodulator function. The technical implementation of these functions is known in the art and familiar to the skilled person.

FIG. 24 is wholly schematic and does not purport to represent the physical layout of the relevant components. In a practical implementation the antenna 426 is typically formed as a conductive loop extending repeatedly around the card close to its perimeter.

In the present example the card 410 further comprises a processing unit 430 and associated memory 432, which may, without limitation, comprise read only memory, non-volatile random access memory and/or EEPROM (electrically erasable programmable read only memory). The memory 432 stores, among other items, a data set which the card 410 is able to transmit to the reader 420 through the contactless interface 426, 428. In the case of a payment card, this data set includes in particular the identity and security information needed for authorization of a financial transaction. In this case its transmission to malfeasors would pose a security risk to the user. The data set typically includes data which is written to the card before its delivery to the end user.

FIG. 25 depicts a contactless card 450 which embodies the present invention, which has in the present embodiment the features of appearance, architecture and function described above with reference to FIGS. 1 to 4, and which additionally comprises a user-actuable switch 452. The switch may be of a mechanical type, having two contacts which are brought into contact by applied pressure, or may be a capacitive type, being sensitive to the local change of dielectric permittivity provided by the presence of e.g. a fingertip, or may be a piezoelectric device e.g. a piezoelectric film or button, or may be a pressure sensitive switch, or may take any other suitable form. The switch 452 is provided on a face of the contactless card 450. It may be provided only on one face of the contactless card 450. But in the embodiment depicted the switch comprises components 452, 454 on both the front and rear faces of the contactless card 450, so that actuation of the switch (i.e. changing its state) involves applying a finger/thumb tip concurrently to each, which can be done easily by gripping the contactless card 50 between thumb and finger, as depicted in FIG. 26.

The contactless card 450 defaults to a first state in which the transmission of at least selected card data through the contactless interface 426, 428 is prevented. Actuation of the switch 452 changes the contactless card 450 to a second state in which transmission of the relevant data through the contactless interface is enabled. But the card remains in the second state only until:
(a) a predetermined period elapses after placement of the contactless card 450 in the second mode; or
(b) a read of the contactless card 450 takes place.

In this way it is ensured that supply of the card data is normally inhibited. A malfeasor who attempts, while for example the contactless card 450 is being carried in a pocket or purse, to read the card remotely will therefore not be able to obtain the card data.

To make a transaction, the user will typically present the contactless card 450 to reader 420 whilst actuating the switch 452. The contactless card 450 is powered by the interrogating field 422 and adopts the second mode of operation due to the actuation of the switch 452, making it possible for the card to supply the card data to the reader 420, to facilitate the transaction.

There could potentially be an opportunity for a malfeasor to read the card data from the contactless card 450 while the card is in the second mode, in the course of the transaction. But any such opportunity is minimized because the card 450 is configured to return to the first mode as soon as it has been read. Any risk of the card 450 being placed in the second mode for a protracted period, e.g. due to inadvertent actuation of the switch 452, is avoided because the card returns to the first state after the said predetermined period, which may be of the order of 10 seconds. The return of the card to its first state takes place even if the user continues to actuate the switch 452.

If the user ceases to actuate the switch 452 during the predetermined period, the card may return without delay to the first state. Alternatively it may remain in the first state until the predetermined period expires.

In some embodiments supply of any data through the contactless interface 426, 428 is disabled in the first mode. In other embodiments the contactless card 450 is able to supply certain information whilst in the first mode, and additionally to supply the selected card data whilst in the second mode. In one such embodiment the selected card data serves to enable financial transactions above a default limit. So in this embodiment the switch 452 serves to create a time limited window for making a transaction above the default limit. The user can make transactions below the limit without making use of the switch 452, and can make larger transactions by actuating the switch whilst presenting the contactless card 450.

The above described embodiments serve as examples only of the manner in which the present invention can be implemented. Numerous possible variants and alternatives will be apparent to the skilled reader.

Invention 5

In a contactless interaction the card 510 is read by a remote reader 520 (FIG. 27) which may for example be a point of sale device used to authorize a financial transaction. A modern point of sale device typically interacts with the user through a user interface which includes a screen 521 capable of displaying prompts for the user to take actions, and other information. The reader need not be in physical contact with the card 510. The reader 520 interrogates the card through an interrogating electromagnetic field 522. In response the card 510 transmits data to the reader 520 through a suitably modulated data transmission electromagnetic field 524.

FIG. 28 is a highly simplified representation of the architecture of the electronics of the card 510 as they pertain to exchange of data through the contactless interface. This is presented by way of example and not limitation. Other architectures may be adopted in embodiments of the present invention. The card 510 has a contactless interface comprising an antenna 526, which is depicted in this example as an inductive element, and associated interface electronics 528. The card 510 is in this example of the “passive” type which runs on power harvested through the antenna 526 from the interrogating electromagnetic field 522 generated by the reader 520. The invention may however be implemented in “active” cards having an on-board power supply. The interface electronics 528 comprise a voltage regulator through which power received from the interrogating electromagnetic field 522 is supplied to the card's other circuitry, and an RF modulator/demodulator function. The technical implementation of these functions is known in the art and familiar to the skilled person.

FIG. 28 is wholly schematic and does not purport to represent the physical layout of the relevant components. In a practical implementation the antenna 526 is typically formed as a conductive loop extending repeatedly around the card close to its perimeter.

In the present example the card 510 further comprises a processing unit 530 and associated memory 532, which may, without limitation, comprise read only memory, non-volatile random access memory and/or EEPROM (electrically erasable programmable read only memory). The memory 532 stores, among other items, a data set which the card 510 is able to transmit to the reader 20 through the contactless interface 526, 528. In the case of a payment card, this data set includes in particular the identity and security information needed for authorization of a financial transaction. In this case its transmission to malfeasors would pose a security risk to the user. The data set typically includes data which is written to the card before its delivery to the end user.

FIG. 29 depicts a contactless card 550 which embodies the present invention, which has in the present embodiment the features of appearance, architecture and function described above with reference to FIGS. 1 to 4, and which additionally comprises a plurality of user-actuable switches 552. The switches may be of a mechanical type, having two contacts which are brought into contact by applied pressure, or may be a capacitive type, being sensitive to the local change of dielectric permittivity provided by the presence of e.g. a fingertip 554, or may be piezoelectric devices, e.g. piezoelectric films or buttons, or may be pressure sensitive switches, or may take any other suitable form. The switches 552 are provided on a face of the contactless card 550, specifically the front face, in the present embodiment. In other embodiments the switches may however be on the rear face, or may use pads, electrodes or other means on both faces of the card, e.g. so that actuation involves touching two sides of the card using finger and thumb. Switches suitable for the purpose and capable of integration in the structure of a contactless card are known to the skilled person.

The switches 552 are able to be used in a challenge and response type interaction at a point of sale in which, having presented the contactless card 550 to the reader 520 to establish communication between them, the user is prompted by the reader 520 to provide an input using the switches 552 carried on the card. The user actuates the switches 552 to provide the response. Some action (typically a financial transaction, although the invention is applicable to other types of transaction including control of a door or other access barrier) is then either authorized or not authorized based on the user's response. In this way the present invention can provide additional security against fraudulent transactions, especially at a point of sale. The challenge and response process requires human input and decision making in the authorization process.

The number of switches may vary without departing from the scope of the present invention. FIG. 29 shows a contactless card 550 having three switches arranged along a short edge of the card, to be easily actuated by fingertip 554. FIG. 30 shows an alternative card 550 having four switches 552 arranged along a long edge.

In the discussion below the action being authorized will in each example be a payment being made at a point of sale, but it should be understood that the present invention is applicable to authorization of other actions, for example unlocking a door or other access control barrier.

The interaction between the user and the system may take a variety of different forms.

In one form of challenge and response interaction, the reader 520 provides the user with a prompt which requires a specific response in order to obtain authorization of the transaction. In FIG. 30 the user interface 521 takes the form of a screen of the card reader 520 and displays a simple prompt identifying one of the switches 552. In this example the switches are numbered and the prompt presents the user with the number of the switch to be actuated, in order to enable the transaction to proceed. In FIG. 31 the card shows a symbol 556 in connection with each switch 552 and the prompt takes the form of the symbol (designated 558 where it is displayed in the user interface 521) associated with the switch which is to be actuated, which in this case is a triangle. In other embodiments the prompt could take the form of a colour, with that colour being displayed through the reader's user interface 521 and the switches 552 being associated with respective colours.

The input to be provided by the user may be related to the nature of the transaction. In particular it may correspond to the value of the transaction. In FIG. 32 each of the switches 552 is associated with a value range displayed on or adjacent the relevant switch. The user interface 521 of the point of sale device displays the actual value of the transaction in hand, and the user is required to select the value range in which that falls by actuating the appropriate switch. In other interactions the user may set a value limit on card transactions using the same switches 552.

The prompt provided to the user need not convey to him/her the input required. Instead, the user may be provided with, or given the ability to select, a personal identifier input intended to be confidential to the user. Authorization of a transaction requires the user to provide this input. This could be as simple as a number or selection of a single button. FIG. 33 provides an example, where the user is prompted simply to press the button corresponding to the personal identifier input. A sequence of switch actuations could be required (e.g. each in response to an individual prompt) to give more permutations. To avoid repeated use of a single button 552 which might leave visible traces on the card 550, the user interface 521 may display a prompt which represents a scrambled ordering of the buttons, so that the user must identify the button to be pressed based both on this display and on knowledge of his/her personal identifier input. For example, looking again at FIG. 31, the user's personal identifier input may be the triangle. The user interface 521 can display the symbols in randomized order, so that the user must select the switch 552 corresponding to the triangle in the display.

The user interface 521 may take a variety of forms. Typically it will comprise a display screen. But an alternative is to use a relatively small number of discrete light sources. Specifically, some point of sale devices currently in use have a set of indicator lights in the form of four LEDs. These can be used to provide the required prompt to the user to actuate a specific switch 552, each LED corresponding to a specific switch. For the visually impaired, audible prompts may be given. For the deaf blind, tactile prompts may be provided. Certain types of interface or prompt may be disabled for certain users, e.g. to avoid giving a colour based prompt to a user with colour blindness, or giving certain linguistic prompts to dyslexic users.

Any of the types of response discussed above may be used singly or in sequence or combination, providing more response permutations and so greater security. Multiple challenge and response cycles may be used to authorize a single transaction.

A predetermined number of wrong attempts may be permitted before some security action is taken, such as blocking transactions through the contactless card 550, or adjusting a transaction value limit.

The effect of a valid challenge and response exchange may be to open a time limited window for authorization of transactions. It may be to open a time limited window for transactions to be carried out subject to an increased limit on transaction value. Thus for example a timer may be activated on completion a valid response, which will enable the transaction—or the raised transaction value limit—until the predetermined time has elapsed, after which transactions are disabled, or the transaction value limit returns to a default value.

The switches 552 may be used by a user during an interaction with the reader 520 to provide an emergency signal and/or to indicate that the user is under duress. One form of crime associated with payment cards involves placing the user under some form of duress (e.g. by threatening the user with a weapon) and so forcing them to carry out a transaction, which might for example be purchase of an item for the malfeasor. A certain choice of switch or response may be known to the user to trigger an emergency signal. A specific switch 552 may serve as the duress signal. Alternatively all wrong inputs may serve as the duress signal. In some examples repetition of the duress signal may be required, to guard against false alarms.

Authorization may be implemented by the card or by the reader or by another system. In one embodiment, the

The payment system may be configured to respond suitably. This response may entail allowing the transaction to go forward but alerting law enforcement agencies. It may involve photographing the scene, e.g. using a camera carried by the point of sale device or using closed circuit television if that is available.

For the sake of security, the data exchanged between the reader 520 and the card 550 may exclude information identifying the actual response to be provided by the user. This may be achieved using known hashing techniques. The reader 550 necessarily stores the required response, which might for example be a combination of switches. Suppose—in the case of the card depicted in FIG. 30 having four switches—that the required response is to actuate the first and third switches. That response may be represented numerically, e.g. by the binary number 1010. That number need not be transmitted between the reader 550 and the card 520. The reader displays the required prompt. The user provides input through the switches. The user's input is likewise represented numerically, e.g. (assuming that the user makes the correct input) by the binary number 1010. That number is hashed by the card, and the hash value is transmitted to the reader. The reader hashes the value it stores representing the required response and authorizes the transaction if the two match. In that case the reader can authorize the transaction. But alternatively the card may compare the two hashed values and inhibit action unless they match.

Security can be further improved using known “salting” techniques in which a salt value, which may be chosen at random or drawn from some aspect of the transaction itself, is additionally used in generating the hash value. The salt may be sent from card to reader or vice versa, or it may be drawn from data known to both (e.g. data relating to the transaction in hand). The process need not be based on a hashing function as such but may utilize any suitable mathematical function, encryption scheme or other algorithm for converting the data to a secure form.

Reading of data, or of selected data, from the card may be permitted only after a successful challenge and response. For example, the card may be programmed to inhibit transmission of certain data unless a challenge and response sequence has been conducted. Or data on the card may be encrypted, e.g. in such a manner that its decryption is possible only after the user's response has been input.

The data transmitted from the card may be in encrypted form, to prevent it from being used by an unauthorized party. In one such example, the data despatched from the card is salted and hashed, the salt being formed by the user's response as supplied through the switches carried by the card. In this case, provided that the user's response correctly matches the prompt provided by the reader, the salt is known to both the reader (which provides the prompt) and the card (through the user's response) but is not available to some third party attempting to read the card. Hence the embodiment provides an additional level of security. This approach may be implemented using encryption techniques other than salting and hashing. Any suitable encryption key may be used, which is (a) known to the reader and forms the basis of the prompt and (b) is input to the card by the user in the response, and is then used to encrypt data read from the card.

The above described embodiments serve as examples only of the manner in which the present invention can be implemented. Numerous possible variants and alternatives will be apparent to the skilled reader.

1. A data tag comprising:
a memory for storing a data set,
a contactless interface for supplying data from the memory to a remote reader, the contactless interface being configured to be interrogated through an electromagnetic field from the reader,
a plurality of sensors which are spatially separated and which are configured to sense the interrogating electromagnetic field, and
a processing device configured to receive outputs from the sensors representative of the interrogating field and to enable supply of data from the data set through the contactless interface if variability of the sensed outputs is sufficient to indicate that the reader and the data tag are in close proximity, and to disable supply of data from the data set through the contactless interface if variability of the sensed outputs is not sufficient to indicate that the reader and the data tag are in close proximity.

2. The data tag as claimed in claim 1 which is a contactless card.

3. The data tag as claimed in claim 2 which is a payment card.

4. The data tag as claimed in claim 2, wherein the sensors are spaced across a two-dimensional area of the card.

5. The data tag as claimed in claim 1, wherein the sensors are arranged in a grid pattern.

6. The data tag as claimed in claim 4, wherein the sensors are directional.

7. The data tag as claimed in claim 1, wherein the sensors are sensitive to the magnetic field component of the interrogating electromagnetic field.

8. The data tag as claimed in claim 1, wherein the sensors are Hall-effect sensors.

9. The data tag as claimed in claim 1, wherein the processing device is configured to compare outputs from the plurality of sensors and to establish variability between the sensors as a basis for determination of proximity of the data tag to the reader.

10. The data tag as claimed in claim 1, wherein the processing device is configured to monitor variation of sensor outputs over time as a basis for determination of proximity of the data tag to the reader.

11. The data tag as claimed in claim 1, wherein the processing device is configured to enable supply of data if distance from the data tag to the reader is determined to be 10 cm or less.

12. The data tag as claimed in claim 1, wherein the processing device is configured to enable supply of data if distance from the data tag to the reader is determined to be 1 cm or less.

13. The data tag as claimed in claim 1, wherein the processing device is configured to enable supply of data if distance from the data tag to the reader is determined to be 2 mm or less.

14. (canceled)

15. (canceled)

16. (canceled)

17. The data tag as claimed in claim 1, wherein the sensors are responsive to the magnetic field component of the interrogating electromagnetic field.

18. A contactless payment card comprising:
a memory for storing a data set,
a contactless interface for supplying data from the memory to a remote reader, the contactless interface being configured to be interrogated through an electromagnetic field from the reader,
a plurality of sensors which are spatially separated and which are configured to sense the interrogating electromagnetic field, and
a processing device configured to receive outputs from the sensors representative of the interrogating field and to enable supply of data from the data set through the contactless interface if variability of the sensed outputs is sufficient to indicate that the reader and the contactless payment card are in close proximity, and to disable supply of data from the data set through the contactless interface if variability of the sensed outputs is not sufficient to indicate that the reader and the contactless payment card are in close proximity.

19. The contactless payment card as claimed in claim 18, wherein the processing device is configured to enable supply of data if distance from the data tag to the reader is determined to be 10 cm or less.

20. The contactless payment card as claimed in claim 18, wherein the sensors include Hall-effect sensors which are spatially separated and spaced across a two-dimensional area of the contactless payment card.

21. The contactless payment card as claimed in claim 20, wherein the sensors are directional and arranged in a grid pattern.

22. A contactless payment card comprising:
a memory for storing a data set,
a contactless interface for supplying data from the memory to a remote reader, the contactless interface being configured to be interrogated through an electromagnetic field from the reader,
a plurality of Hall-effect sensors which are spatially separated and spaced across a two-dimensional area of the card, the sensors being configured to sense the interrogating electromagnetic field and their response varying with the direction of the interrogating electromagnetic field, and
a processing device configured to receive outputs from the sensors representative of the interrogating electromagnetic field and to determine variability thereof, and based on said variability to determine distance of the contactless payment card from the reader, and to enable supply of data from the data set through the contactless interface if variability of the sensed outputs is sufficient to indicate that the reader and the contactless payment card are in close proximity, and to disable supply of data from the data set through the contactless interface if variability of the sensed outputs is not sufficient to indicate that the reader and the contactless payment card are in close proximity.

23. The contactless payment card as claimed in claim 22, wherein the processing device is configured to enable supply of data if distance from the data tag to the reader is determined to be 10 cm or less.
